(19) United States
(12) Patent Application Publication
(10) Pub. No.: US 2017/0147790 A1
(43) Pub. Date: May 25, 2017

(54) System and Method for Identity and Role Base Access Management

(71) Applicant: HCL Technologies Limited, Noida (IN)

(72) Inventors: Mehul Ravjibhai PATEL, Cary, NC (US); Sunil AGARWAL, Bedminster, NJ (US)

(73) Assignee: HCL Technologies Limited, Noida (IN)

(21) Appl. No.: 14/950,257

(22) Filed: Nov. 24, 2015

(51) Int. Cl. G06F 19/00; H04L 29/06; H04L 29/08

(52) U.S. Cl. CPC G06F 19/363; H04L 67/306; H04L 63/102; H04L 63/08

(57) ABSTRACT

The present disclosure relates to system(s) and method(s) for enabling role based privileged access to a user for accessing a plurality of applications. The system is configured to maintain a user profile in a profile database. The user profile stores authentication details and a functional role as well as application role and privilege level corresponding to each application from a plurality of applications, wherein the plurality of applications are configured for conducting clinical trials. Further, the system is configured to provide the user a privileged access to the plurality of application based on the application role of the user and the privileged level associated with the application role.

### CROSS-REFERENCE TO RELATED APPLICATIONS AND PRIORITY

The present application does not claim priority from any patent application.

### TECHNICAL FIELD

The present disclosure in general relates to the field of access management. More particularly, the present invention relates to a system and method for managing user access to clinical trial applications.

### BACKGROUND

'Now-a-days, pharmaceutical companies and Clinical Research Organizations (CRO's) conduct hundreds of clinical trials every year across multiple therapeutic areas for making human lives better. However, while conducting clinical trials, user access management and privilege control on multiple clinical applications always gets a second priority. Further, there is no systemic approach followed across industry for access management which results in inefficient management of clinical trials.

The solutions available in the art for clinical trial management do not have a centralized location to verify what access role a user has on various clinical applications, as well as what clinical study protocol he has access to. Some of these systems do not even have mechanism to manage and store internal and external user base. This results in several business challenges during clinical trials management of CROs and often leads to audit findings which could pose delays in bringing much needed drugs to patients. Further, there are various access management solutions available in the art for access management but none of these solutions are uniquely configured to solve the business challenge faced while conducting clinical trials. These access management solutions require customization and implementation which is too expensive to implement and manage, especially for mid to small size companies. These access management solutions are not clinical trial focused and need almost 80-90% of customization.

Further, some of the access management solutions are incapable of proactively managing user's access to support critical business functions during initial study set-up, study conduct and closeout as well as facilitate regulatory audit inspections.

Some of the challenges in existing systems for user access management are:

Manual user management process maintained at the department level

Inconsistent user information across applications with multiple authentications

Identification of internal (employee) and external (non-employee) users

Corrective actions based on findings during audits

Manual and time consuming effort to find the level of access for a user across all clinical applications

Multi-tenant study access for sponsor and CRO is difficult to Configure

### SUMMARY

This summary is provided to introduce aspects related to systems and methods for enabling role base access to application and the aspects are further described below in the detailed description. This summary is not intended to identify essential features of the claimed subject matter nor is it intended for use in determining or limiting the scope of the claimed subject matter.

In one embodiment, a system for enabling role based privileged access to a user for accessing a plurality of applications is illustrated. The system comprises a processor coupled to a memory, wherein the processor is configured to execute programmed instructions stored in the memory. The processor may execute a programmed instruction for maintaining a user profile in a profile database. The user profile stores authentication details and a functional role assigned to the user. The functional role of the user is linked with at least one application role associated with each application of a plurality of applications, wherein each application role defines a privilege level to access the one or more applications of the plurality of applications. Once the user profile is generated and stored in the profile database, the processor may be configured to execute a programmed instruction for authenticating a user requesting access to an application from the plurality of applications, based on the authentication details provided by the user and the user profile stored in the profile database. Once the user is authenticated, in the next step, the processor may be configured to execute a programmed instruction for determining at least one application role of the user corresponding to the application, wherein the at least one application role is determined based on the functional role of the user stored in the user profile. Further, the processor may be configured to execute a programmed instruction for determining the privilege level of the user to access the application, based on the at least one application role corresponding to the user for the selected application. Finally, the processor may be configured to execute a programmed instruction for providing a privileged access to the user to access the selected application, based on the determined privileged level.

In one embodiment, a method for enabling role based privileged access to a user for accessing a plurality of applications is illustrated. The method may comprise maintaining a user profile in a profile database, wherein the user profile stores authentication details and a functional role assigned to the user, wherein the functional role of the user is linked with at least one application role associated with each application of a plurality of applications, and wherein each application role defines a privilege level to access the one or more applications of the plurality of applications. The method may further comprise authenticating a user requesting access to an application from the plurality of applications, based on the authentication details provided by the user and the user profile stored in the profile database. Once the user is authenticated, in the next step, the method may further comprise determining at least one application role of the user corresponding to the application, wherein the at least one application role is determined based on the functional role of the user stored in the user profile. The method may further comprise determining the privilege level of the user to access the application, based on the at least one application role corresponding to the user. The method may further comprise providing a privileged access to the user to access the application, based on the determined privileged level of the user for the application. In an embodiment, the aforementioned method may be executed by a processor using programmed instructions stored in a memory coupled with the processor.

In one embodiment, non-transitory computer readable medium embodying a program executable in a computing device for enabling role based privileged access to a user for accessing a plurality of applications, is disclosed. The program comprises a program code for maintaining a user profile in a profile database, wherein the user profile stores authentication details and a functional role assigned to the user, wherein the functional role of the user is linked with at least one application role associated with each application of a plurality of applications, and wherein each application role defines a privilege level to access the one or more applications of the plurality of applications. The program further comprises a program code for authenticating a user requesting access to an application from the plurality of applications, based on the authentication details provided by the user and the user profile stored in the database. The program further comprises a program code for determining at least one application role of the user corresponding to the selected application, wherein the at least one application role is determined based on the functional role of the user stored in the user profile. The program further comprises a program code for determining the privilege level of the user to access the selected application, based on the at least one application role corresponding to the user. The program further comprises a program code for providing a privileged access to the user to access the application, based on the determined privileged level of the user for the application.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for enabling role based privileged access to a user for accessing a plurality of applications, in accordance with an embodiment of the present subject matter.

FIG. 2 illustrates the system for enabling role based privileged access to the user for accessing the plurality of applications, in accordance with an embodiment of the present subject matter.

FIG. 3 illustrates a block diagram for enabling role based privileged access to the user for accessing the plurality of applications, in accordance with an embodiment of the present subject matter.

FIG. 4 illustrates a flow diagram for enabling role based privileged access to the user for accessing the plurality of applications, in accordance with an embodiment of the present subject matter.

### DETAILED DESCRIPTION

The present subject matter relates to a system for enabling role based privileged access for accessing a plurality of applications. In one embodiment, the system is implemented over a cloud-based platform and enables the user of the system to connect with a plurality of applications customized for conducting clinical trials. The system utilizes centralized identity/access management and role based access control, where user's functional role is mapped to at least one application role corresponding to a plurality of applications for conducting clinical trials.

In one embodiment, the system enables identity generation, authorization, authentication, auditing, resource management and reporting for a user. The system is flexible and easy to integrate with pharmaceutical research and development labs as well as Clinical Research Organizations (CRO). The system 102 is secure and scalable in managing functional role and data access privileges to the plurality of applications from a centralized location. The system also provides extensive support for externalization of clinical trials with data access rights and roles specific to different partners. In one embodiment, the system is cloud-based, delivered as SaaS and custom built for clinical trials. Further, the system also enables provisioning/de-provisioning users from accessing the plurality of applications.

While aspects of described system and method for enabling role based privileged access to a user for accessing a plurality of applications may be implemented in any number of different computing systems, environments, and/or configurations, the embodiments are described in the context of the following exemplary system.

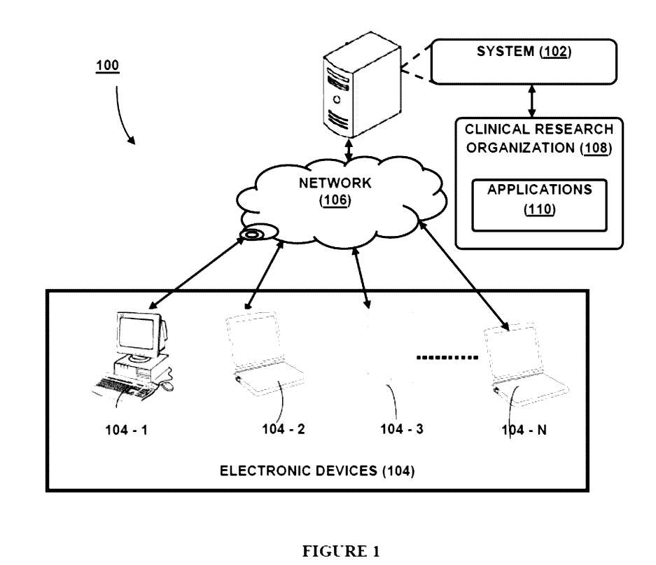

Referring now to FIG. 1, a network implementation 100 of a system 102 to enable role based privileged access to a user for accessing a plurality of applications is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106. Further, the system 102 is connected to a pharmaceutical research and development lab 108, wherein the research and development lab or a Clinical Research Organization hereafter CRO 108. The CRO 108 may be configured to store and run a plurality of applications 110. These applications 110 may be focused for conducting clinical trials for research purposes. The plurality of applications may include but are not limited to Electronic Data Capture (EDC) applications, Clinical Trial Management System (CTMS) applications, Safety System application, Enterprise Portal and Interactive Voice Response System (IVRS) applications and the like for capturing clinical trial data.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

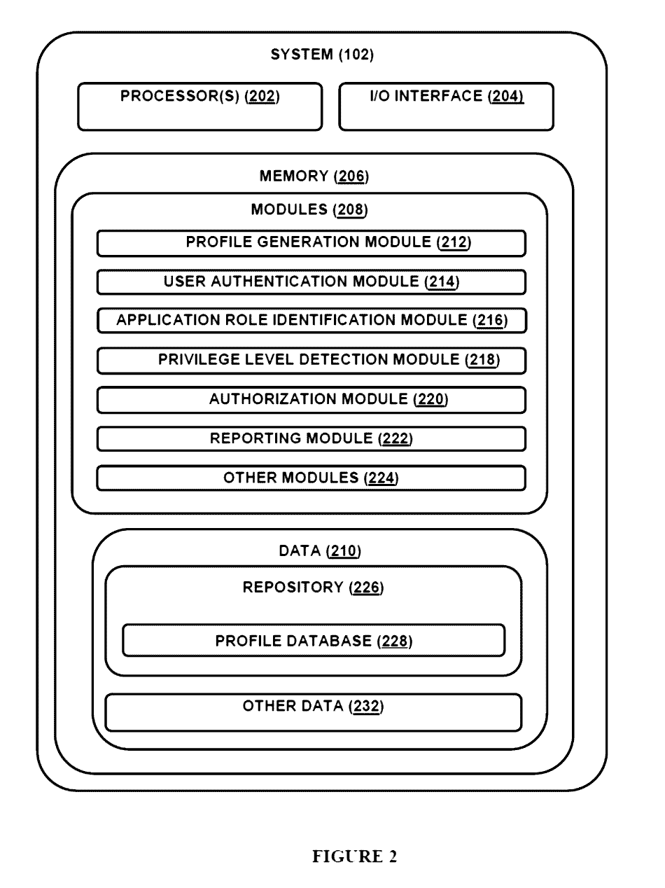

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a profile generation module 212, a user authentication module 214, an application role identification module 216, a privilege level detection module 218, an authorization module 220, a reporting module 222, and other modules 224. The other modules 224 may include programs or coded instructions that supplement applications and functions of the system 102.

The data 210, amongst other things, serves as a repository for storing data processed, received, and generated by one or more of the modules 208. The data 210 may also include a repository 226, and other data 230. In one embodiment, the repository 226 may be configured to store a profile database 228. The profile database 228 is configured to store user profile associated with user of the system 102. In one embodiment, the other data 230 may include data generated as a result of the execution of one or more modules in the other module 224.

In one implementation, the system 102 is configured to maintain a list of plurality of application 110 in a Clinical Research Organization (CRO) 108 that can be accessed by a user through the system 102. The plurality of applications 110 may be software applications configured to conduct clinical trials and maintain record of each clinical trial conducted at CRO 108. For the purpose of accessing the plurality of applications 110, at first a user may use the client device 104 to connect with the system 102 via the I/O interface 204. The user may register him with the system 102 using the I/O interface 204 in order to use the system 102. In one embodiment, at the time of registration, the system 102 may generate a user profile by accepting information from the user over the I/O interface 204. The I/O interface 204 may prompt the user to input authentication details such as user name, password, professional details, and functional role of the user in the CRO 108. The functional role of the user may include a Manager, a Clinical Manager, Data analyst and the like. Further, the profile generation module 212 is configured to generate a user profile storing authentication details and a functional role associated with a user.

In one embodiment, an application role of the user may be assigned dynamically and may vary from application to application. For instance, a user with a functional role of data analyst may be appointed as a site coordinator or data manager for an EDC application and the same user may be appointed a project manager for a CTMS application. In other words, though the functional role of the user remains the same, his application role may change from application to application. In order to capture this, the profile generation module 212 is configured to maintain a record of the functional role and a corresponding at least one application role, of the user, associated with each application of the plurality of applications 110. The application role defines a privilege level to access one or more applications of the plurality of applications 110. The privilege level may be selected from read data, read-write data, modify data, delete data, download data, transfer data and combinations thereof For example, a site coordinator is assigned a privilege level to view the site related information. However, the site coordinator cannot make any changes to the backend data. In one embodiment, the privilege levels for each application role may be defined by an administrator of the CRO. Further, the profile generation module 212 records the authentication details, functional role of the user and application role corresponding to each application from the plurality of applications 110 in the profile database 228 in the form of a user profile. In a similar manner user profile for all the users of the system 102 are generated and maintained in the profile database 228.

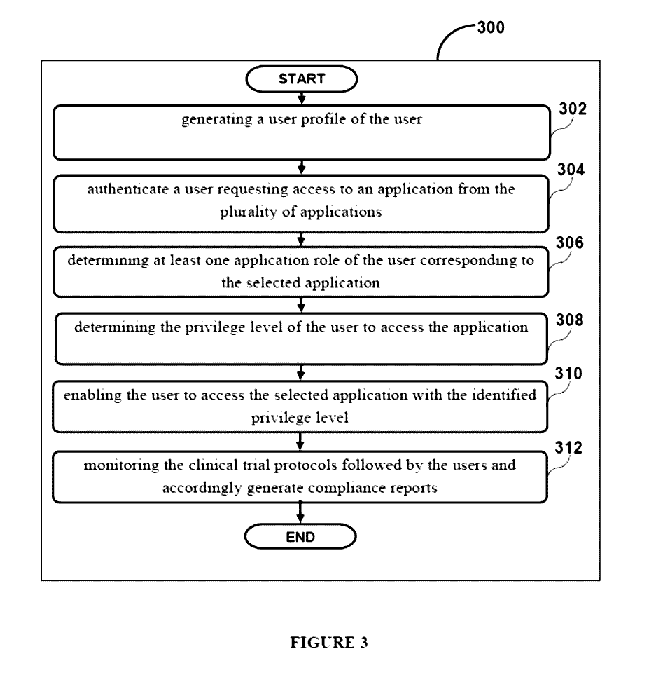

In one embodiment, once the user profiles are generated, in the next step, the user authentication module 214 is configured to authenticate a user requesting access to an application from the plurality of applications. For the purpose of authentication, the authentication details provided by the user are compared to the authentication details stored in the user profile of the user. Once the user is authenticated, the application role identification module 216 determines at least one application role of the user corresponding to the selected application. For the purpose of determining the application role, the application role identification module 216 first identifies the functional role of the user that is stored in the user profile and then determines the application role corresponding to the selected application. Once the application role is determined, in the next step, the privilege level detection module 218 is configured to determine the privilege level of the user to access the application based on the at least one application role corresponding to the selected application. After determining the privileged level, the authorization module 220 is configured to enable the user to access the selected application with the identified privilege level. Further, the reporting module 222 is configured to monitor the clinical trial protocols followed by the users and accordingly generate compliance reports for the users. The method for generating the user profile and providing role based access to each user is further illustrated with respect to the block diagram of FIG. 3.

Referring now to FIG. 3, a method 300 for enabling role based privileged access to a user for accessing a plurality of applications is disclosed, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, for the purpose of accessing the plurality of applications in the CRO 108, a user profile is generated by the profile generation module 212. For generating the user profile, a user may use the client device 104 to connect with the system 102 via the I/O interface 204. At the time of registration, the I/O interface 204 prompts the user to input authentication details such as user name, password, professional details, and functional role of the user in the CRO 108. Further, the profile generation module 212 is configured to generate a user profile storing authentication details and a functional role associated with the user. In one embodiment, the role of the user may vary from application to application. In other words, the functional role of the user remains the same, but his application role may change from application to application. In order to capture this, the profile generation module 212 is configured to maintain a record of the functional role and a corresponding at least one application role, of the user, associated with each application of a plurality of applications. Further, the application role defines a privilege level to access an application of the plurality of applications. The privilege levels for each application role may be defined by an administrator of the CRO 108. Further, the profile generation module 212 records the authentication details, functional role of the user and application role corresponding to each application from the plurality of applications in the user profile and stored the user profile in the profile database 228. In a similar manner user profile for all the users of the system 102 are generated and maintained in the profile database 228.

At block 304, once the user profiles are generated, in the next step, the user authentication module 214 is configured to authenticate a user requesting access to an application from the plurality of applications 110. For the purpose of authentication, the authentication details provided by the user at the time of login into the system 102 are compared to the authentication details stored in the user profile.

At block 306, once the user is authenticated, the application role identification module 216 determines at least one application role of the user corresponding to the selected application. For the purpose of determining the application role, the application role identification module 216 first identifies the functional role of the user that is stored in the user profile and then determines the application role corresponding to the selected application. For example, a user may be assigned with a functional role of a Manager. However, for an EDC application, the application role of the user may be a Data Manager and for a CTMS application, the application role of the user may be an Approver. This information is stored in the user profile of the user in a tabulated format. In case if the user selects the EDC application at the time of login into the system 102, the role identification module 216 first determines the functional role of the user (i.e. Manager) and based the application (i.e. EDC) selected by the user, the application role of Data Manager is identified.

At block 308, once the application role is determined, in the next step, the privilege level detection module 218 is configured to determine the privilege level of the user to access the application based on the identified application role of the user.

At block 310, after determining the privilege level, the authorization module 220 is configured to enable the user to access the selected application with the identified privilege level.

At block 312, the reporting module 222 is configured to monitor the clinical trial protocols followed by the users and accordingly generate compliance reports for the user.

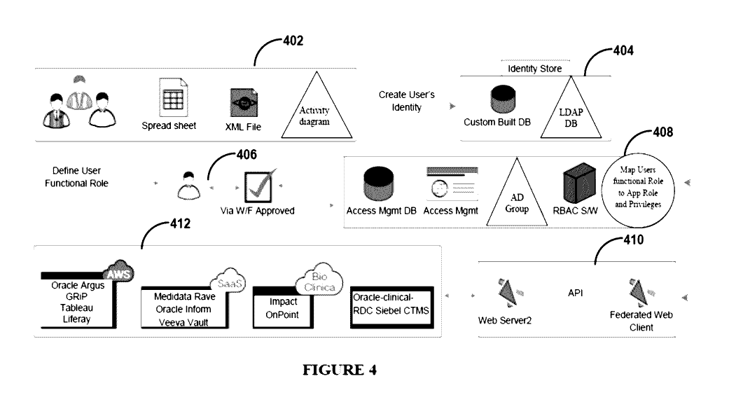

Referring now to FIG. 4, a flow diagram 400 for enabling role based privileged access to a user for accessing a plurality of applications is disclosed, in accordance with an embodiment of the present subject matter.

At stage 402, information associated with a plurality of users of the clinical research organization 108 may be prompted to provide their personal details. These details may be accepted in the form of Spread sheets, XML files or active directory. These details may include the authentication details of the user as well as personal information of the users.

At stage 404, the user profile (user's identity) is stored in a profile database/Identity store. The identity store may be in the form of custom built database or a LDAP database configured to record the user profiles of the users.

At stage 406, an administrator of the CRO 108 may assign different functional roles to each of the users. Once the functional roles are assigned, a verification stage is initiated to confirm functional role assigned to each of the users.

At stage 408, based on the functional role of the user, each user is assigned with an application role and a privilege level corresponding to each application in the CRO 108. In one embodiment, the application role and the privilege level may be assigned by an administrative group of the CRO 108. The mapping between the functional role of the user and application roles is maintained in an access management database.

At stage 410 and 412, the system 102 enables a web interface with APIs in order to enable the user to access the application from the plurality of applications 110. The applications 110 may be selected from Oracle Argus™, HCL GRiP™, HCL Tableau™, HCL Liferay™, Medidata Reva™, Oracle Inform™, Veeva Vault™, Impact OnPoint™, Oracle-Clinical-RDC™, and Siebal CTMS™. The access to these applications is provided based on the application role and the privileged level assigned to the user.

In one embodiment, the system 102 provides the following advantages:

Centralized process for management of clinical application users with a holistic view of a user, applications, application functions and studies user has access to.

Automatic/automated setup of various clinical applications, saving time, and eliminating errors.

Complete auditing of all functions in clinical trials.

Easy to control, manage and set up governance on user access management.

Automated identity account de-provisioning and life-cycle management.

Avoiding wrong access/Data Privacy (i.e. application and data security).

Reduced support costs and downtime.

Faster and consistent setup granting the user access to various applications.

User mapped to functional role, application, application role, and studies.

Improved Efficiency by removing manual audit/verification due to centralized source.

Simple reporting.

Although implementations for methods and systems for enabling role based privileged access to a user for accessing a plurality of applications in clinical trials has been described, it is to be understood that the appended claims are not necessarily limited to the specific features or methods described. Rather, the specific features and methods are disclosed as examples of implementations for enabling role based privileged access.

What is claimed is:

1. A system for enabling role based privileged access to a user for accessing a plurality of applications, the system comprising:
a memory; and
a processor coupled to the memory, wherein the processor is configured to execute programmed instructions stored in the memory for:
maintaining, in a profile database, a user profile storing authentication details and a functional role associated with a user, wherein the functional role is linked with at least one application role associated with each application of a plurality of applications, and wherein each application role defines a privilege level to access one or more applications of the plurality of applications;
authenticating a user requesting access to an application from the plurality of applications, based on the authentication details provided by the user and the user profile stored in the database;
determining at least one application role of the user corresponding to the application, wherein the at least one application role is determined based on the functional role of the user stored in the user profile;
determining the privilege level of the user to access the application based on the at least one application role corresponding to the user; and
provisioning a privileged access to the user to access the application, based on the determined privileged level.

2. The system of claim 1, wherein each application from the plurality of application is configured to perform clinical trials.

3. The system of claim 1, wherein the functional role associated with the plurality of application include a manager, a clinical manager, a data analyst, a data reviewer, and a scientist.

4. The system of claim 1, wherein the application role associated with the user includes an approver, data reviewer, a project manager, a site coordinator, and a data manager.

5. The system of claim 1, wherein privilege level is selected from read data, read-write data, modify data, delete data, download data, transfer data and combinations thereof

6. A method for enabling role based privileged access to a user for accessing a plurality of applications, the method comprising:
maintaining, by a processor in a profile database, a user profile storing authentication details and a functional role associated with a user, wherein the functional role is linked with at least one application role associated with each application of a plurality of applications, and wherein each application role defines a privilege level to access one or more applications of the plurality of applications;
authenticating, by the processor, a user requesting access to an application from the plurality of applications, based on the authentication details provided by the user and the user profile stored in the database;
determining, by the processor, at least one application role of the user corresponding to the application, wherein the at least one application role is determined based on the functional role of the user stored in the user profile;
determining, by the processor, the privilege level of the user to access the application based on the at least one application role corresponding to the user; and
provisioning, by the processor, a privileged access to the user to access the application, based on the determined privileged level.

7. The method of claim 6, wherein each application from the plurality of application is configured to perform clinical trials.

8. The method of claim 6, wherein the functional role associated with the plurality of application include a data analyst, a data reviewer, and a scientist.

9. The method of claim 6, wherein the application role associated with the user includes a project manager, a site coordinator, and a data manager.

10. The method of claim 6, wherein privilege level is selected from read data, read-write data, modify data, delete data, download data, transfer data and combinations thereof

11. A non-transitory computer readable medium embodying a program executable in a computing device for enabling role based privileged access to a user for accessing a plurality of applications, the program comprising:
a program code for maintaining, in a profile database, a user profile storing authentication details and a functional role associated with a user, wherein the functional role is linked with at least one application role associated with each application of a plurality of applications, and wherein each application role defines a privilege level to access one or more applications of the plurality of applications;
a program code for authenticating a user requesting access to an application from the plurality of applications, based on the authentication details provided by the user and the user profile stored in the database;
a program code for determining at least one application role of the user corresponding to the application, wherein the at least one application role is determined based on the functional role of the user stored in the user profile;
a program code for determining the privilege level of the user to access the application based on the at least one application role corresponding to the user; and
a program code for provisioning a privileged access to the user to access the application, based on the determined privileged level.
